(19) United States
(12) Patent Application Publication
(10) Pub. No.: US 2009/0030769 A1
(43) Pub. Date: Jan. 29, 2009

(54) System and Method for Latency Management Assistant

(75) Inventors: Mark ORTTUNG, Menlo Park, CA (US); Timothy A. MILLER, San Francisco, CA (US); Brian GODDEN, Los Gatos, CA (US); Patrick NEWMAN, Palo Alto, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 11/829,823

(22) Filed: Jul. 27, 2007

(51) Int. Cl. G06Q 10/00; G06F 17/00

(52) U.S. Cl. 705/9

(57) ABSTRACT

One embodiment provides a method, that may be implemented on a system, for receiving an electronic communication from a user, the communication identifying a delay incurred or to be incurred by the user, relative to a pre-identified schedule of events; in response to receiving the electronic communication, accessing data identifying the pre-identified schedule of events; generating one or more options to reschedule one or more events of the schedule of events to account for the identified delay of the user; sending to the user the one or more options to reschedule one or more events of the schedule of events to account for the identified delay of the user; and, in response to receiving at least one of a selection from the user, sending notification of the reschedule to one or more of attendees and service providers of the scheduled events.

### BACKGROUND OF THE INVENTION

Often, for various reasons, some within and some beyond the control of a traveler or a business person, appointments cannot be kept on time. For example, a traveler may be victim of transportation system delays. In other cases, a delay at an appointment may be due to a meeting that is important and cannot be cut short running past its anticipated ending time. In any case, appointments and meeting times are often wasted when one party does not attend, resulting in, at the least, annoyance and inconvenience for the other attendee(s), and sometimes resulting in more serious damaging consequences.

In some cases, a GPS-dependent method and system known to the inventor may be used to notify other parties and to adjust schedules as needed. In other cases, however, the traveler does not have a GPS phone, and therefore using the system of the previously cited invention is not possible. However, most business people traveling today have the ability to make a phone call, to send an email or an SMS, or to communicate with a digital system by some electronic means.

Therefore, what is clearly needed is system and method that proactively recognizes the potential for such a problem, or recognizes early-on that such a problem is arising, and notifies the attendees of the meeting at risk of either a delay or of the need to reschedule. What is further needed is a system and method for rescheduling meetings that seem at risk of being delayed or missed and for reorganizing and rebooking facilities and services attendant on the meeting as needed.

What is further needed is a system and method that allows a person to send an electronic notification about being late to an automated system, and by said message, to set into motion an automated system for a rescheduling, a modification, or a cancellation of an event.

### DESCRIPTION OF THE EMBODIMENTS

The disclosure is illustrated by way of example and not limitation in the figures of the accompanying drawings in which like references indicate similar elements

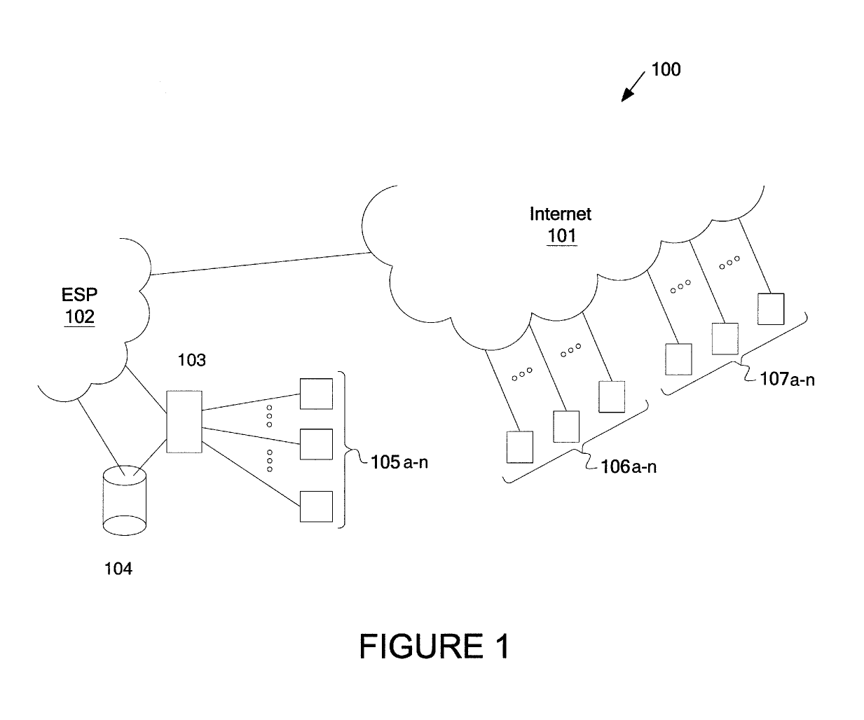

FIG. 1 shows an exemplary overview of a system 100 according to one embodiment of the current invention;

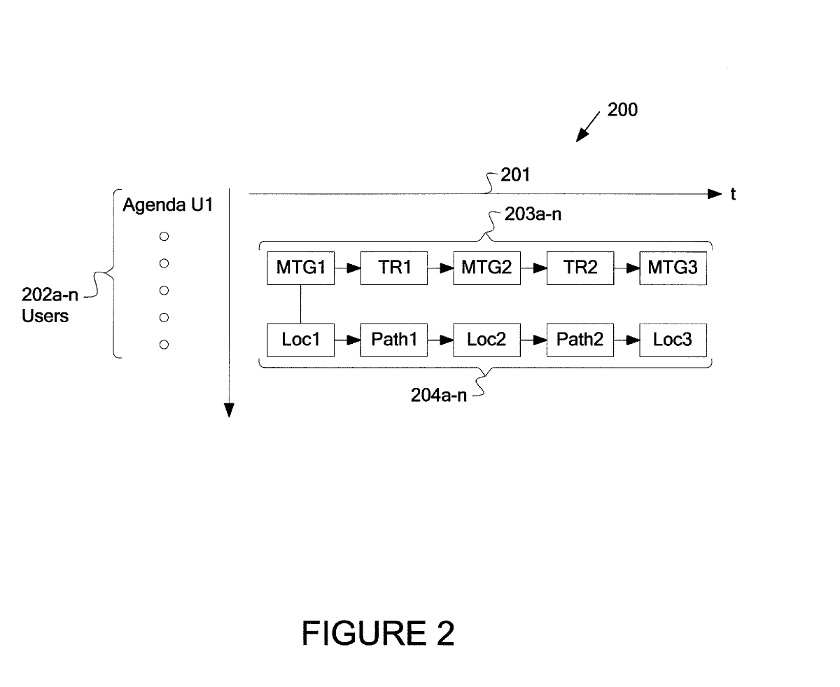

FIG. 2 shows an exemplary overview of a calendar system 200, such as would reside in a PIM or PIM database of many users 202a-n;

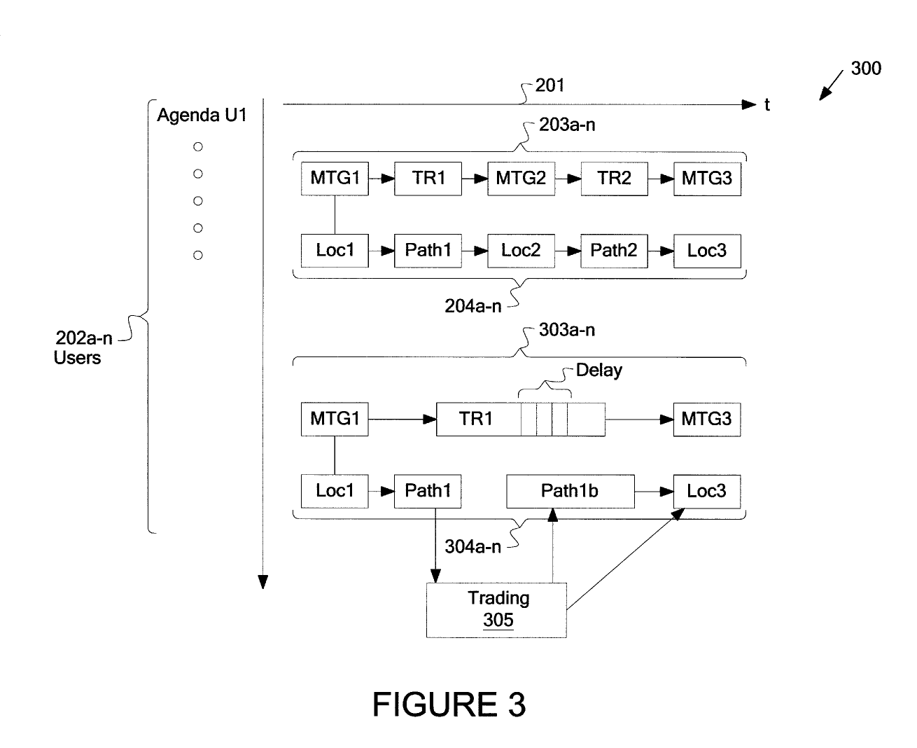

FIG. 3 shows an exemplary calendar system 300 accounting for a variation in actual time of agenda U1 of user 1 202a;

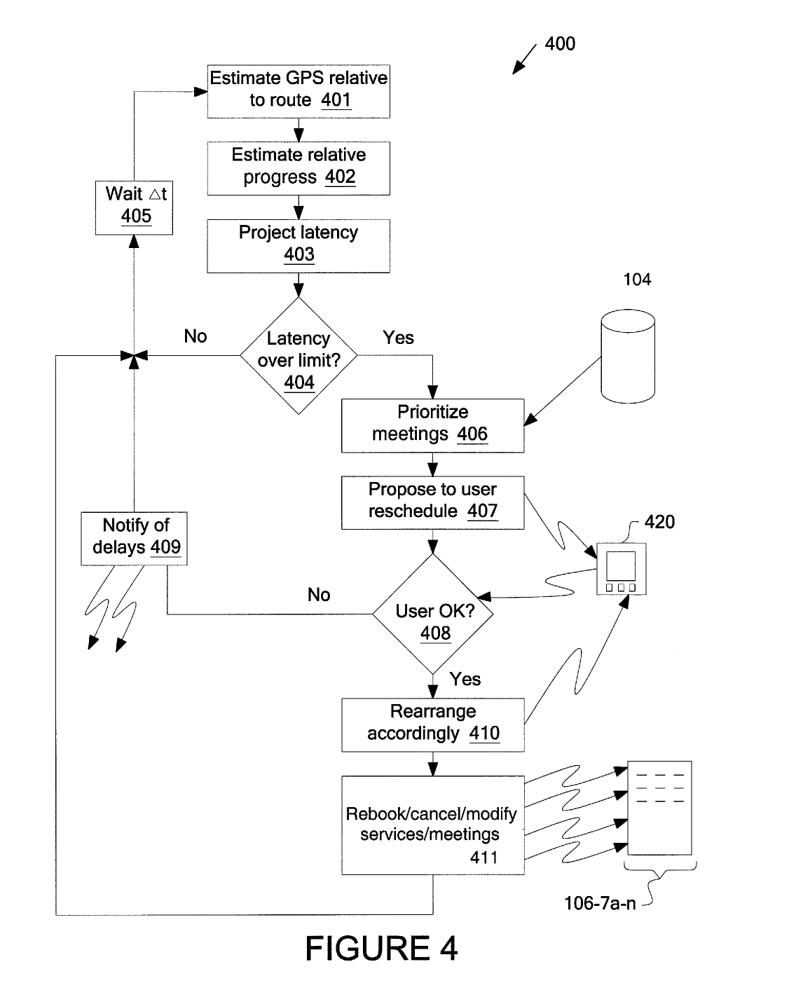

FIG. 4 shows an exemplary process 400 for tracking and rebooking events according to one embodiment of the present invention;

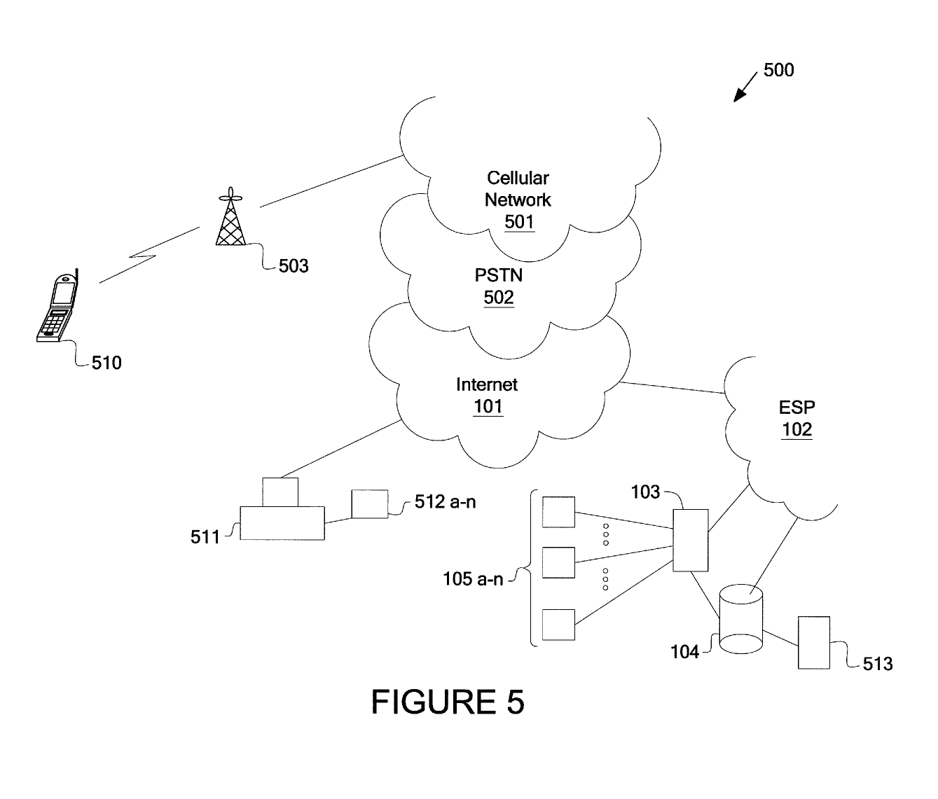

FIG. 5 shows an overview of an exemplary system 500 for automated rescheduling, modification, or cancellation of an event, according to one embodiment of this invention; and

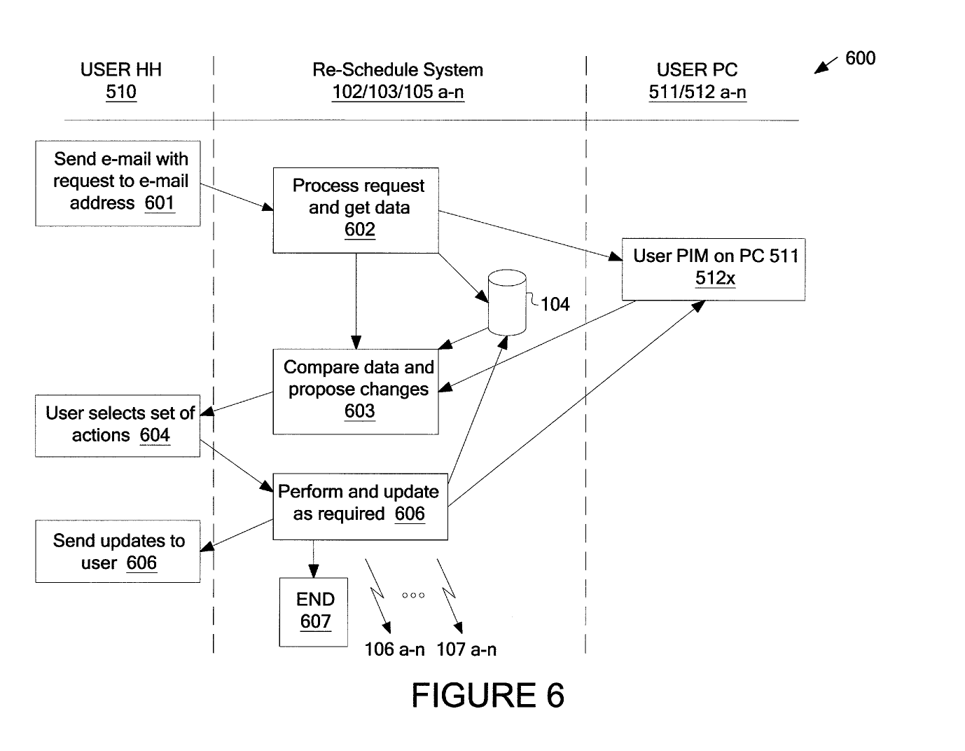

FIG. 6 shows an exemplary time diagram of the notification and rescheduling process 600 according to one embodiment of the current invention.

### SUMMARY

Some embodiments of the present invention are summarized in this section.

One embodiment provides a method, that may be implemented on a system, for receiving an electronic communication from a user, the communication identifying a delay incurred or to be incurred by the user, relative to a pre-identified schedule of events; in response to receiving the electronic communication, accessing data identifying the pre-identified schedule of events; generating one or more options to reschedule one or more events of the schedule of events to account for the identified delay of the user; sending to the user the one or more options to reschedule one or more events of the schedule of events to account for the identified delay of the user; and, in response to receiving at least one of a selection from the user, sending notification of the reschedule to one or more of attendees and service providers of the scheduled events.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

FIG. 1 shows an exemplary overview of a system 100 according to one embodiment of the current invention. An electronic services portal ESP 102 connects to a server 103 and a data repository 104. The server hosts software instances 105a-n of the present invention, which, depending on the implementation of the system, may be one, several, or many instances. These software instances are to be considered only exemplary indications of how the software could be installed in server 103 and how it could work in conjunction with ESP 102, personal information managers (PIMs, not shown), and main data repository 104. System 102 connects via Internet 101 to system users 106a-n and suppliers 107a-n. It is clear that these connections could also be through direct connection, through a phone system, or through any other suitable networking method, known or to be invented.

### Proactive Agenda Management

FIG. 2 shows an exemplary overview of a calendar system 200, such as would reside in a PIM or PIM database of many users 202a-n. Shown in detail is an exemplary agenda U1 of user 1 202a (not shown). Along timeline 201 are meetings and transportation events 203a-n, and the locations and movement paths 204a-n associated with events 203a-n. For example, if a meeting MTG1 occurs, and a car TR1 has been ordered to pick up a person at location 1, it is safe to assume that meeting 1 is at or near location 1. The car is also scheduled to deliver the person to location 2, so it is also safe to assume that meeting 2 takes place at or near location 2. Therefore, path 1 may be derived as the most likely path of transportation between location 1 and location 2. Similarly, a person attends meeting 2 and orders car TR2 for transportation along path 2 to meeting 3 at location 3. Tracking can be based on GPS location, time, schedules, and other factors.

FIG. 3 shows an exemplary calendar system 300 accounting for a variation in actual time of agenda U1 of user 1 202a. Transportation TR1 203b is delayed, and thus meetings and the following portions of transportation events 303a-n and locations and movement paths 304a-n are rescheduled. The delay does not allow the following meetings to occur on time. In this example, even though it would have been possible to reschedule meeting 2 and meeting 3, it happens that meeting 3 is of greater importance and a decision has been made to skip meeting 2 and advance the time of meeting 3 as much as is convenient for the other attendee(s).

In some cases, importance can be derived by comparing the relative position of the person(s) to be met in the other company, and the size of the business that is done. In other cases, the user defines importance, for example on a 1-3 scale, or a 1-10 scale. Defaulting based on previous meetings may also be offered. In some cases, a post meeting review may rate the meeting and be used for future meetings as a pre-defined default, or adjusted accordingly.

In some cases, attendees will receive along with the schedule change message an option to vote their preference or decline alternatives, which may or may not be considered.

Tracking software module 305 has observed that transportation TR1 203b did not progress along path 1 from location 1 to location 2 according to schedule using a GPS function of a smart phone device, as is described below in relation to the description of FIG. 4. Module 305 has accordingly initiated communication with the user. As a result the decision was made by either the user or the system based on predefined rules and preferences to cancel meeting 2 and rearrange transportation for meeting 3, and also possibly to rebook meeting.

FIG. 4 shows an exemplary process 400 for tracking and rebooking events according to one embodiment of the present invention. In process 401 the GPS position of the user along the predefined route of the agenda is calculated or determined. The user's GPS position can easily be obtained from any of various newer cell phones, which commonly offer GPS functions. In some cases the GPS data may need to be enabled in the network, so system applications can query the GPS. In other cases, specialized software may be installed in a phone or other GPS device that would allow, for example, only the vendor's software to obtain the tracking data, without broadcasting the data to general phone service providers. In process 402 the current location is compared to the location where the user is supposed to be at the current time and the system estimates the progress of the event, relative to the original agenda. Based on the divergence of the user's actual position from the planned position, and in some cases, factoring in current traffic conditions and other elements affecting progress, the system projects an amount of latency for planned events.

In process 404 the process branches. If the latency is not over a certain limit (no), which may be a predetermined limit or a dynamically calculated limit, the system loops to process 405, where the system waits for a predetermined period of time before continuing back to process 401 to restart. For example, a latency of 15 minutes at a meeting may be acceptable in many cases, so by calculating the current location and the remaining way, you can predict the ETA. Also, traffic condition may be used.

The delay before continuing back to process 401 provides certain granularity to the process, because the system would be over-burdened if it continually processed data on a real-time basis. For example, the system could restart the process every minute, every 5 minutes, every 10 minutes, or after any other suitable period of time. If the latency is over the limit (yes), the system moves to process 406, where it prioritizes meetings based on information obtained from database 104 (e.g., based on predefined rules, historic data and preferences).

Based on the derived priorities, in process 407 the system calculates one or more rescheduling proposals for the user and sends them to the user's communication device 420. This device could receive such a message as an SMS, an IM, an email, as a phone call with a voice interaction system, or by any other suitable means of communication. In some cases, the system could call a designated alternate, if the user does not want to be interrupted or if he is out of reach. In process 408 the user sends a response. If the user does not accept any of the system's proposals (no), the system sends a message in process 409 to other parties, informing them of expected delay times for the next event(s). If the user accepts one of the system's proposals (yes), then in process 410 the system checks arrangements to implement the proposal with other parties 106a-n and suppliers 107a-n as needed and in process 411 it goes about the necessary rebooking, canceling, or modifying services and meetings. For example, in process 410 the system may need to check a flight first, before changing an appointment, etc., in process 411.

Although FIG. 4 shows the confirmation sent to the user in process 410, additional confirmations may also be sent to the user after the system finishes making all arrangements and receiving confirmations from all other parties 106a-n and 107a-n. The system then continues to track the progress of the revised agenda, looping back through the process and making further adjustments if necessary. Although this example shows the delay being caused by transportation problems, it is clear that delays may be caused by any of a wide variety of factors, such as extended meeting times or delays by the user in starting out on the agenda (getting a late start). However, the principles and the proposed automatic rearrangements of schedules are the same in all cases.

### Latency Management Assistant

FIG. 5 shows an overview of an exemplary system 500 for automated rescheduling, modification, or cancellation of an event, according to one embodiment of this invention. A user sends a message, in this example, via mobile electronic communication device 510 to a wireless tower 503. In other cases, such a request could come from any Internet- or other communication-enabled device, including but not limited to PCs, phones both wired and wireless, Internet kiosks, Internet appliances, etc. Typically tower 503 would connect to a cellular network 501 and to either PSTN 502 or Internet 101. The message would then go to electronic services portal ESP 102 or to a user's computer 511. The message then triggers a software instance to contact other parties 106a-n and suppliers 107a-n to make necessary adjustments to accommodate the user's delay. Said software instance could be one of those among software instances 512a-n, which could be, for example, the user's Personal Information Manager (PIM) and associated software to manage interactions between the PIM and the user's message on the user's computer, or software instance 105a-n, which resides on ESP server 103 and uses data repository 104, which repository contains a copy of the user's schedule 513.

FIG. 6 shows an exemplary time diagram of the notification and rescheduling process 600 according to one embodiment of the current invention. In this example, the software instances that accomplish the automated rescheduling reside in the ESP 502. Three columns, left to right, show the three parties in an exemplary rescheduling over time. These parties are the user 510's mobile device in the left column; the rescheduling system components ESP 102, which include server 103, one or more software instances 105a-n, in the center column; and in the right column, the user's computer 511 with its software instances 512a-n. The passage of time during the process is shown proceeding from top to bottom in each column. In process 301, the user sends an email from a hand-held device, such as a mobile phone 510, saying, in effect, that he will be late by some number of minutes, for example, such as 10 minutes, or 30 minutes, and requesting the system to notify, in this case, for example, by electronic communication, the other meeting attendee(s) and service providers.

In process 602, the rescheduling system receives the message. The system retrieves the data it needs to send out notifications, in this case from the user's PIM 512x stored in his PC 511, and/or from data repository 104. In process 603, the system matches its retrieved data to the rescheduling required by the user's delays, and, after processing this data in a similar manner as that discussed earlier, proposes certain changes, which change proposal it sends back to the user's mobile device by email or other suitable form of electronic communication. In process 604, the user selects his desired changes, such as canceling, moving, rescheduling, rebooking, etc. from those proposed by the system and sends his selections back to the system by the same electronic communication means. In process 605, the system implements the user's desired changes and sends messages notifying the other attendee(s) 106a-n and service providers 107a-n of the changes. In process 606 the user receives confirmation of the implemented changes and in process 607 the process ends.

It is clear that many modifications and variations of this embodiment may be made by one skilled in the art without departing from the spirit of the novel art of this disclosure. In particular, in addition to electronic communication means such as email, SMS, IM, etc., messages may also be exchanged by means of a voice XML or IVR system or other, similar automated voice telephone system. In other cases, other suitable, similar messaging media or web interfaces may be offered for interaction with the system to achieve an exchange of information. These variations do not depart from the broader spirit and scope of the invention, and the examples cited here are to be regarded in an illustrative rather than a restrictive sense.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A computer-implemented method comprising:
receiving an electronic communication from a user, the communication identifying a delay incurred or to be incurred by the user, relative to a pre-identified schedule of events;
in response to receiving the electronic communication, accessing data identifying the pre-identified schedule of events;
generating one or more options to reschedule one or more events of the schedule of events to account for the identified delay of the user;
sending to the user the one or more options to reschedule one or more events of the schedule of events to account for the identified delay of the user; and
in response to receiving at least one of a selection from the user, sending notification of the reschedule to one or more of attendees and service providers of the scheduled events.

2. The computer-implemented method of claim 1, wherein the received electronic communication is transmitted from a mobile communication unit.

3. The computer-implemented method of claim 2, wherein the scheduled events comprise one or more of scheduled meetings, appointments, and travel arrangements.

4. The computer-implemented method of claim 3, wherein the generating one or more options to reschedule is based on the identified priorities of one or more scheduled events remaining.

5. The computer-implemented method of claim 4, wherein the generating one or more options to reschedule is based on the identified priorities of one or more scheduled events remaining.

6. The computer-implemented method of claim 5, wherein the one or more options to reschedule one or more events of the schedule of events, comprises at least one of canceling, rescheduling, and rebooking an event.

7. A machine-readable medium having stored thereon a set of instructions which when executed perform a method comprising:
receiving an electronic communication from a user, the communication identifying a delay incurred or to be incurred by the user, relative to a pre-identified schedule of events;
in response to receiving the electronic communication, accessing data identifying the pre-identified schedule of events;
generating one or more options to reschedule one or more events of the schedule of events to account for the identified delay of the user;
sending to the user the one or more options to reschedule one or more events of the schedule of events to account for the identified delay of the user; and
in response to receiving at least one of a selection from the user, sending notification of the reschedule to one or more of attendees and service providers of the scheduled events.

8. The machine-readable medium of claim 7, wherein the received electronic communication is transmitted from a mobile communication unit.

9. The machine-readable medium of claim 8, wherein the scheduled events comprise one or more of scheduled meetings, appointments, and travel arrangements.

10. The machine-readable medium of claim 9, wherein the generating one or more options to reschedule is based on the identified priorities of one or more scheduled events remaining.

11. The machine-readable medium of claim 10, wherein the generating one or more options to reschedule is based on the identified priorities of one or more scheduled events remaining.

12. The machine-readable medium of claim 11, wherein the one or more options to reschedule one or more events of the schedule of events, comprises at least one of canceling, rescheduling, and rebooking an event.

13. A system comprising:
means for receiving an electronic communication from a user, the communication identifying a delay incurred or to be incurred by the user, relative to a pre-identified schedule of events;
means for accessing data identifying the pre-identified schedule of events, in response to receiving the electronic communication;
means for generating one or more options to reschedule one or more events of the schedule of events to account for the identified delay of the user;
means for sending to the user the one or more options to reschedule one or more events of the schedule of events to account for the identified delay of the user; and
means for sending notification of the reschedule to one or more of attendees and service providers of the scheduled events, in response to receiving at least one of a selection from the user.
